(19) United States
(12) Patent Application Publication
(10) Pub. No.: US 2018/0117738 A1
(43) Pub. Date: May 3, 2018

(54) Angular Positioning Fly Tying Vise

(71) Applicant: Christiaan Klumper, Poulsbo, CO (US)

(72) Inventor: Christiaan Klumper, Poulsbo, CO (US)

(21) Appl. No.: 15/701,150

(22) Filed: Sep. 11, 2017

Related U.S. Application Data
(60) Provisional application No. 62/393,040, filed on Sep. 11, 2016.

(51) Int. Cl. B25B 1/22; B25B 1/08; B23Q 3/02

(52) U.S. Cl. CPC B25B 1/22; B23Q 3/02; B25B 1/08

(57) ABSTRACT

The subject invention provides a means to tie a fly pattern for a fishing method by means of the fly tying vise mechanism. In general, the invention employs technology that allows the individual to position the various parts of the vise in multiple ways to achieve virtually unlimited angular positioning of the jaws. The invention employs an offset cam that allows for an adjustable friction applied to the hook jaw mechanism that is attached to a long vertical post, mounted on a heavy pedestal, providing stability for the vise. The pedestal employs several applications for storing or attracting tools and hooks and magnetizing jaws. The offset cam can be adjusted up and down and rotate 360 degrees horizontally around the vertical post; can be rotated 360 degrees vertically to turn the cam from a horizontal to a vertical position; allows the jaws to be moved up and down, relative to the cam to accommodate different sizes hooks; and, allows the jaws to rotate 360 degrees. The invention also employs a swiveling, vertically adjustable back snatch, which is a flexible arm that is used to hold the bobbin thread holder or material pliers that hold feathers and other material during the tying process.

### CROSS-REFERENCE TO RELATED APPLICATIONS

This application claims benefit of Provisional Application No. 62/393,040 filed Sep. 11, 2016.

### REFERENCES CITED

### Referenced By

U.S. Patent Documents

| | | |
|---|---|---|
| 2,586,636 | February 1952 | Fischer et al. |
| 3,945,631 | March 1976 | Sander |
| 4,039,178 | August 1977 | Odames |
| 4,094,497 | June 1978 | Stratton |
| 4,119,305 | October 1978 | Anderson |
| 4,134,577 | January 1979 | Price et al. |
| 4,169,562 | October 1979 | Renzetti |
| 4,184,645 | January 1980 | Starling |
| 4,214,739 | July 1980 | Dailey |
| 4,216,948 | August 1980 | Carter |
| D,263,113 | February 1982 | Gehrke |
| 4,322,065 | March 1982 | Doiron |
| 4,375,284 | March 1983 | Doiron |
| 4,544,145 | October 1985 | Norlander |
| D287,263 | December 1986 | Kojima et al. |
| 4,969,636 | November 1990 | Gautam |
| 5,165,673 | November 1992 | Newton, Jr. |
| 5,169,079 | December 1992 | Renzetti |
| 5,230,177 | July 1993 | Hanley |
| 5,537,772 | July 1996 | Cleveland |
| 5,716,020 | February 1998 | Shults |
| 5,775,679 | July 1998 | Strub |
| 5,785,304 | July 1998 | Little |
| 5,809,686 | September 1998 | Abby |
| 5,826,867 | October 1998 | Roby |
| 5,833,221 | November 1998 | Trunko |
| 6,109,601 | August 2000 | St. John, Sr. |
| 6,119,972 | September 2000 | Vogel et al. |
| 6,126,157 | October 2000 | Rutzer |
| 6,364,304 | April 2002 | Strait et al. |
| D461,520 | August 2002 | Olson |
| 6,564,494 | May 2003 | Renzetti |
| 7,566,022 | July 2009 | McKinley et al. |
| 7,950,638 | May 2011 | Su |

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

### Field of the Invention

The AP Vise was designed for the primary purpose of tying flies for fly fishing but may be utilized in any procedure that requires movement around a small object that needs to remain stationary during such procedure. Flies for fly fishing are typically wound on vises that are designed for holding various sizes of fish hooks. Holding these hooks is also an area of importance and requires enough clamping force to prevent any hook movement. A rotary cam for the hook holding jaws is typically placed on a vertical post that is mounted on a stable pedestal. In most cases, a rigid arm that is attached to the vertical post holds a wire of some kind for placing the bobbin thread.

### Description of Prior Art

There are a multitude of previous inventions that involve fly tying vises and, of these, a few involve the rotation of the hook along a center axis, i.e. the center axis being at the tip of the jaws and center of the cam. Fischer, U.S. Pat. No. 2,586,636; Stratton, U.S. Pat. No. 4,094,497; Renzetti, U.S. Pat. No. 4,169,562; Carter, U.S. Pat. No. 4,216,948; Norlander, U.S. Pat. No. 4,544,145; Newton, Jr. U.S. Pat. No. 5,165,673; Renzetti, U.S. Pat. No. 5,169,079; Vogel U.S. Pat. No. 6,119,972; Strait, U.S. Pat. No. 6,364,304. However, these vises do not account for the different height of hook above the tip of the jaws, and do not allow the tier to adjust therefore. Several patents other than those already listed, have asserted claims that their vise jaws rotate laterally around the vertical post. Anderson, U.S. Pat. No. 4,119,305; Price U.S. Pat. No. 4,134,577; Roby, U.S. Pat. No. 5,826,867. Su, U.S. Pat. No. 7,950,638, took this one step further, allowing the jaws to rotate laterally during the tying process.” Others, referenced above, have claimed separate linear motion or rotation of certain parts of their vise but such positioning is highly limited. Furthermore, no previously referenced vise offered the tier a choice between tying with angled jaws or straight jaws.

In sum, issues with previous fly tying vise technology that this invention is designed to remedy, include but are not limited to the following: limited stability due to smaller, less stable pedestals; no measurement system incorporated into the fly tying vise to measure flies; limited or no means to secure fly tying tools and hooks on the pedestal and no means to magnetize or re-magnetize the hooks; limitation of movement around the hook due to the location of the cam, jaws, and hook relative to post that the cam and jaws are mounted to; inability to turn the cam vertically 360 degrees, allowing the tier to change the axis of rotation of the jaws from vertical to horizontal; inability or difficulty adjusting the vise to suit a left-hand dominant tier to a right-hand dominant tier and vice versa; inability to adjust the cam up and down the vertical post relative to the pedestal; limited hook holding power of the jaws, which allows the jaws to spread and/or the hook to slip; limited or no device or application to help the fly tier avoid tying tilted flies; limited or no flexibility for positioning the thread holder or the material pliers; and, the need to choose between straight or angled jaws when purchasing a vise.

### SUMMARY OF THE INVENTION

Those who are skilled in tying flies need the fly fishing hook to be stable in the vise jaws even when excess force is applied. Such stability provides ease of tying when various materials are used. The friction adjustments on the offset cam can be set to the desired force giving complete control over fly tying. The ability to maneuver the various parts of the vise into different desired positions and angles, is ideal for good fly tying and tying different types of the flies. The ability to adjust the jaws, straight or angled, linearly with respect to the cam, allowing the tier to adjust the position of any size hook so that the shank of the hook rotates on a perfect center axis, is ideal for good fly tying. Bringing the bobbin thread holder and the back snatch near the hook at any position is important for the fly tier's' tying method. The art of the present invention implements these attributes in connection with tying a perfect fly. The invention provides the means to tie a fly pattern with ease by arranging the vise at any angular position that is most comfortable for the individual giving total control over the tying method.

In sum, this invention improves or solves the above-described issues with prior art as follows: This invention has a larger, more stable pedestal and when combined with the solid, taller and larger-than-normal vertical post, serves as a platform to hold the back snatch, cam, and accessories; unlike prior art, the pedestal of this invention provides multiple means for storing tools, attracting and securing hooks and re-magnetizing jaws, and for measuring flies and materials; the offset cam does not restrict but allows 360 degree freedom of movement around the hook; the cam/jaw assembly may be moved up and down and 360 degrees horizontally around the vertical post; the jaws rotate 360 degrees and can spin freely or be secured in place at the tier's preference; the horizontal post allows for 360 degree rotation of the cam/jaw assembly, allowing the tier to turn the cam 90 degrees, changing the axis of tying rotation from horizontal or vertical; the invention easily adjusts to accommodate left-hand dominant and right-hand dominant fly tiers; the jaws have superior hook holding power due to improved tensioning system of the jaws; the cam has angular indicator markings that align on the bearing housing and jaw plate adjust, to help prevent the tier from tying tilted flies; the swiveling, flexible back snatch that holds the bobbin thread holder and material pliers is also adjustable up and down and 360 degrees around the vertical post, allowing the tier to move the back snatch almost anywhere the individual finds use for it; includes both a straight jaw plate or angled jaw plate, to suit the preference of any tier; and, these jaw plates allow the tier to adjust the jaws up and down with respect to the cam, allowing the tier to adjust the position of any size hook so that the shank of the hook rotates on a perfect center axis.

### BRIEF DESCRIPTION OF THE DRAWING

FIG. 1 is a perspective view of the vise and vise assembly.

FIG. 2 is a side elevational view of the vise and shows the offset cam and jaws with respect to the vertical post.

FIG. 3 is a side fragmentary elevational view of the vise and shows the offset cam and jaws with respect to the vertical post.

FIG. 4 is a side fragmentary view of the cam/jaw assembly, essentially looking at the cam/jaw assembly straight-on from the perspective of the vertical post.

FIG. 5 is a perspective, fragmentary view of the cam/jaw assembly.

FIG. 6 is an elevational view of the cam/jaw assembly, i.e. looking straight down on the cam/jaw assembly.

FIG. 7 is an elevational view of the vise, i.e. looking straight down on the vise.

FIG. 8 is a fragmentary, perspective view of the cam/jaw assembly

FIG. 9 is a perspective view of the vise.

FIG. 10 is a side view of the jaws and a cross-sectional view of the cam.

FIG. 11 is a side view of the jaws; a cross-sectional view of the cam; and, a view of the jaws when they are rotated vertically 180 degrees.

### DETAILED DESCRIPTION OF THE INVENTION

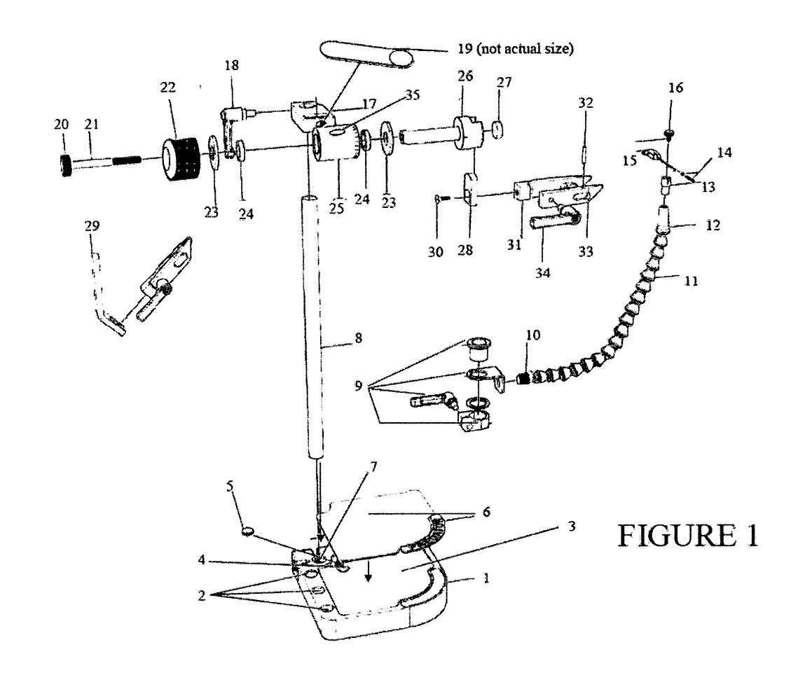

For purposes of this description, the term “cam/jaw assembly” refers to the combination of the cam, which includes a jaw plate release, knurled rotation grip, a bearing housing, and a jaw plate adjust, an angled jaw plate or a straight jaw plate; and, a pair of jaws (see FIG. 1, 20-35). For purposes of this description, the term “cam” refers to the combination of the jaw plate release, knurled rotation grip, bearing housing, and the jaw plate adjust. (see FIG. 1, 20-27, 35).

In reference to the drawings, each drawing shows the fly tying vise or a part thereof, which embodies the present invention. Each individual part or element of the vise is not new per se. However, the present invention is focused on the unique combination of angular positioning achieved by the vise, which, unlike any other vise before it, allows the tier to position the jaws and fish hook in a larger variety of angles than ever achieved by a previous fly tying vise. Please note that direction of rotation, linear movement, and other measurements utilized herein are utilized as a means to illustrate the angular positioning of the vise and may not be exact but are substantially as described.

For purposes of FIG. 1, the invention shall essentially be described from the bottom up and then from left to right along the top. In reference to FIG. 1, which is a perspective view of the invention, the pedestal, 1, is a heavy, metal larger and taller-than-normal pedestal essentially in the shape of a square with the back corner of said pedestal where the sides meet at a ninety degree angle; the opposite ends of the two sides that make up the back corner are slightly rounded off; and, the front side (opposite the back) is rounded off to a smooth curve. Each of the two sides that form the ninety degree back corner of the pedestal has three holes, 2, drilled from the top of, down in to the pedestal along and near the edge, said holes being wide and deep enough wherein a wider range of fly tying tools may be inserted or stored without tipping over or falling out. The pedestal, 1, is further comprised of a milled out flat area, 3, with straight sides, deep enough to help prevent tools, hooks, and other materials from sliding off of the pedestal, and also includes a hole, 4, drilled into the top of the pedestal near the back corner in front of the vertical post, the hole being deep enough to place a strong rare earth magnet, 5, (over which the label, 6, is placed) the magnet being inserted for purposes of attracting hooks and other metal tools and/or for magnetizing or recharging the magnetization of the jaws. The label, 6, is sticky on the bottom side so that it attaches to the pedestal in the in the milled-out flat area, 3, (the label essentially being the shape of the milled-out area) and the top of said label, 6, makes a platform where tools, materials, and hooks can be stored and displays metric measurement and standard measurement for measuring flies and materials. The round hole, 7, at the back corner of the pedestal provides a means for vertically, mounting a large, solid vertical post, 8, and allows the vertical post to be rotated horizontally 360 degrees thereby also rotating the cam/jaw assembly; is secured in place via the mounting bracket once the desired position is reached; and, allows the tier to easily, completely remove the vertical post for storage or travel, with such placement of said vertical post at the back corner of the pedestal being ideal for greater weight distribution when the cam/jaw assembly is placed at its recommended location toward the front corner of the pedestal, providing a good center of gravity and stability during use. The vertical post, 8, serves as a mount for the back snatch, the cam/jaw assembly, and any other future accessories designed specifically to be used with this invention, including snap-on accessories.

Moving up FIG. 1, the vertical post, 8, is further comprised of a back snatch, 9-17, which is a highly flexible, yet strong and stable arm, attached to the vertical post via a mounting bracket, 9, which allows the back snatch to move up and down and 360 degrees around the vertical post. The mounting bracket, 9, is then attached to a threaded connecter, 10, which attaches to a modular hose, 11, that can be adjusted as desired by the tier. The modular hose, 11, of the back snatch screws into a nozzle, 12, and attaches to a tip, 13, which contains a slot where the rod of a material clip, 15, or bobbin thread holder, 14, may be inserted, and then secured by a screw, 16.

Unlike the rigid arms used in previous inventions, the flexibility of the back snatch allows the tier to position the thread holder and material pliers near the hook or in any number of desired positions, while the strength and stability of the back snatch hold it in place. When not in use the back snatch can be moved away from the work area and can easily be removed from the vise entirely, if desired, and replaced when needed.

Moving further up FIG. 1, demonstrates how the cam/jaw assembly attaches to the vertical post, 8, by inserting the vertical post through a hole at the bottom of a clamping mechanism, 17. Such clamping mechanism, 17, allows the cam/jaw assembly to move up and down and rotate horizontally 360 degrees around the vertical post. A lever, 18, screwed into the clamping mechanism, allows the tier to secure the cam/jaw assembly to the vertical post in the desired position. The front of the clamping mechanism connects to a horizontal post, 19 (said horizontal post, 19, pictured in FIG. 1 does not represent the actual shape or size of the horizontal post relative to the rest of the vise). The horizontal post, 19, on the end opposite the one that connects to the clamping mechanism, is pressed into the bearing housing of the cam, 25 (discussed hereafter), thereby connecting the cam/jaw assembly to the vertical post. The horizontal post, 19, rotates vertically 360 degrees, thereby allowing the cam/jaw assembly to rotate vertically 360 degrees. Specifically, the horizontal post allows the cam/jaw assembly to be rotated ninety degrees when using the straight jaw plate (described below), allowing the tier to turn the jaws pointing upwards and change the axis of tying rotation from horizontal to vertical, i.e. allowing an individual to tie parachute patterns.

Beginning on the far left of FIG. 1, towards the top, begins the cam/jaw assembly itself (20-35). The cam of the vise is set approximately a hand's width away from and offset from the vertical post, allowing the freedom of hand movement around the entire cam/jaw assembly in turn giving complete accessibility to the fly while tying. In FIG. 1, the cam begins with the jaw plate release, which is a three-part piece, 20, 21, and 27, which starts at the back of the cam with a black knob, 20, that is attached to a long screw, 21, which is inserted at the back end of the cam, runs through the entire cam (including the shaft of the jaw plate adjust, 26), and puts pressure on the third part of the jaw plate release, a small disk, 27, that sits inside the jaw plate adjust, and when the jaw plate release knob, 20, is turned clockwise, the screw, 21, puts pressure on the small disk, 27, inside the jaw plate adjust, 26, thereby securing the jaw plates, 28-29 (straight, 28, or angled, 29, described hereafter); and, conversely, when the jaw plate release knob, 20, is turned counter-clockwise, the small disk, 27, in the jaw plate adjust goes back into its place in the jaw plate adjust taking pressure off of the jaw plate, thereby releasing the jaw plate. The vise is designed for quick release of the jaw and for jaw exchange and allowing the tier to switch from tying with angled jaws or straight jaws, a choice which no previous vise has offered.

The next part of the cam in FIG. 1, is the knurled rotation grip, 22, which is a hollow cylinder knurled on the outside for grip, and inserted around the screw, 21, and the shaft of the jaw plate adjust, 26, and directly in front of the black knob of the jaw plate release, 20. Said knurled rotation grip rotates in unison with the jaw plate adjust, 26, jaw plate, 28 or 29, and jaws, 31-34. allowing the tier to turn said knurled rotation grip, thereby rotating said jaw plate and jaws vertically 360 degrees when the cam is in the horizontal position or rotate said jaw plate and jaws horizontally 360 degrees when the cam is in the vertical position.

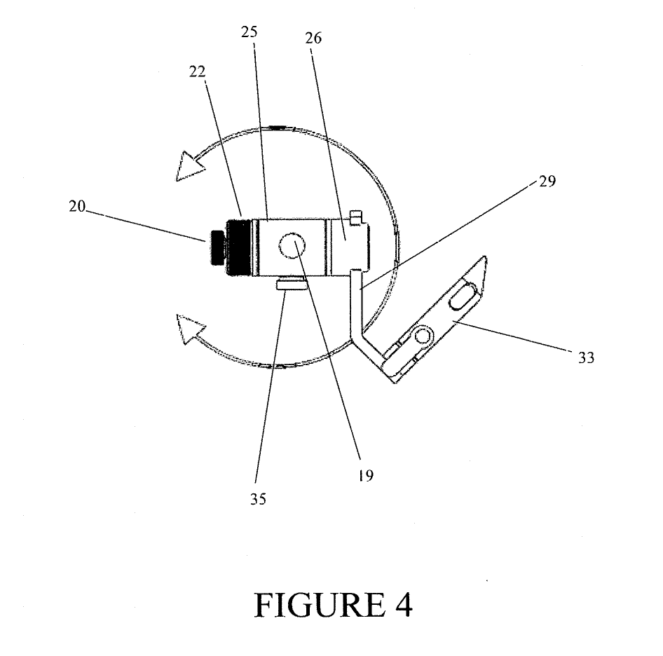

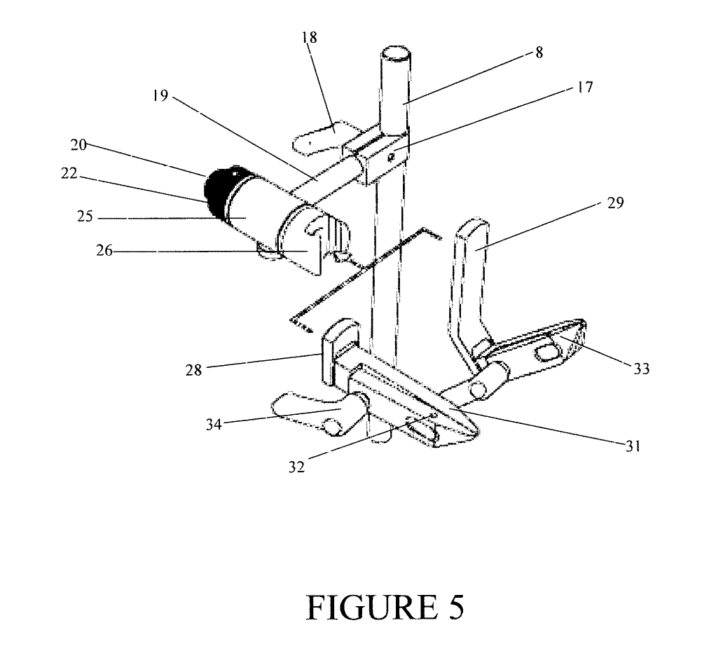

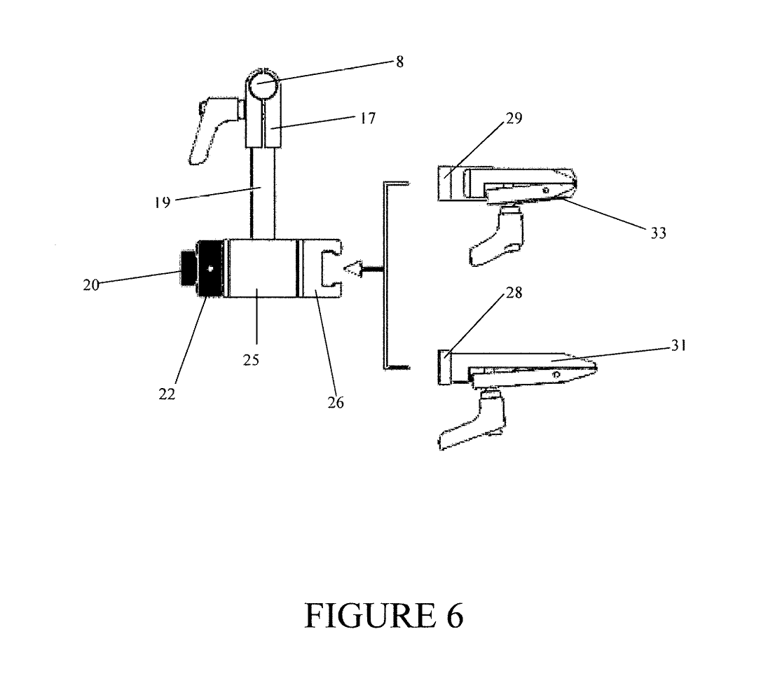

The next part of the cam in FIG. 1, is the bearing housing, 25, which is placed in front of the knurled rotation grip, 22, around the screw, 21, and shaft of the jaw plate adjust, 26, after one of two washers, 23, are inserted. The bearing housing, is comprised of a hollow cylinder into the side of which the horizontal post, 19, is pressed (see FIG. 4, FIG. 5, and FIG. 6). The back end (closest to the knurled rotation grip and the first washer) and the front end (closest to the second washer and jaw plate adjust) of the bearing housing have identical sealed ball-bearings, 24, pressed into them. Unlike the knurled rotation grip, 22, and the jaw plate adjust, 26, the bearing housing, 25, remains stationary when the knurled rotation grip is turned. However, when the horizontal post, 19, is turned, the bearing housing, 25, turns in unison with it, thereby turning the entire cam/jaw assembly. Another hole is drilled through the top and bottom of the bearing housing, wherein a screw is inserted that serves as a micro-tension adjustment screw, 35, that when tightened, places pressure on the tubular-shaft portion of the jaw plate adjust, 26 (described in the next paragraph), thereby stopping the free-spin rotation of the jaws and securing the jaws in the desired position. This hole drilled through the top and bottom of the bearing housing, also serves to allow easy left-hand/right-hand conversion, described below. Finally, the bearing housing, 25, includes angular indicator markings on the front end every ninety degrees and every fifteen degrees between the ninety degree marks, which align with the angular markings on the back end of the jaw plate adjust, 26, for indicating trueness of plane while tying.

The final major part of the cam in FIG. 1, is the jaw plate adjust, 26, which is placed in front of the bearing housing, after the second of two washers, 23, is inserted. The jaw plate adjust, 26, is a cylinder with a hollow shaft at its back end which points toward the back of the cam through which the long screw, 21, is inserted and screwed into. The back end of the jaw plate adjust has angular indicator markings that correspond to the angular indicator markings on the bearing housing, 25. By lining up the angular indicator markings on the bearing housing, 25, and the jaw plate adjust, 26, the tier can avoid tying tilted flies, offering a more precision in tying than ever before. The front end of the jaw plate adjust, 26, has a vertical notch cut into it with a countersunk hole in the center, inside which the small disk, 27, i.e. the third part of the jaw plate release, is inserted.

The next parts of the cam/jaw assembly in FIG. 1, are the jaw plates, i.e. the straight jaw plate, 28, and the angled jaw plate, 29. Each of said jaw plates is a metal plate (the straight jaw plate, 28, being a straight metal plate, and the angled jaw plate, 29, being a metal plate bent at an angle partway down) that is inserted into said notch in the front end of the jaw plate adjust, 26, described above, and is secured or released by the jaw plate release (20, 21, 27); giving the fly tier a choice between tying with a straight-neck jaw (“straight jaws”), i.e. when the jaws, 30-34, are connected to the straight jaw plate, or tying with an angled-neck jaw (“angled jaws”), i.e. when the jaws, 30-34, are connected to the angled jaw plate. Each jaw plate allows the jaws to be adjusted up and down within the notch of the jaw plate adjust, 26, letting the tier adjust the position of any size hook to allow the shank of the hook to rotate on a perfect center axis, as opposed to prior art, which only allowed the jaws to rotate on a perfect center axis.

The final part of the invention described in FIG. 1, is the set of jaws, 30-34, that hold the hook or other object in place. The jaws are comprised of an adjustable jaw, 31, and fixed jaw, 33. The fixed jaw, 33, has an oval post, which is inserted into the oval hole cut out of the adjustable jaw, 31. Said oval post of the fixed jaw, 33, has a small hole that lines up with a small hole in the adjustable jaw, when they are placed property together, through which a small hinge pin, 32, is inserted, thereby connecting the fixed and adjustable jaws. Both the adjustable jaw, 33, and fixed jaw, 31, have tap-threaded female holes drilled into them through the sides of each jaw toward the back end, through which a lever, 34, is screwed into (either into the fixed jaw for left-hand tiers, 31, or into the adjustable jaw, 32, for right-hand tiers). The lever, 34, provides pressure against the adjustable jaw toward the back, pushing it open at the back, which, in turn, applies pressure to the tip of the jaws, where the hook is placed. The tip of the jaws, are placed at the top, i.e. the jaws are angled down and back from the tip, to allow for greater access to the hook so that the tier does not have to reach over any obstructions. The jaws are attached to the jaw plate (either the straight jaw plate, 28, or the angled jaw plate, 29) by a small screw, 30, which is inserted through the angled or the straight jaw plate into the back of the fixed jaw, 31. The hook is inserted into the tip of the jaws between the fixed jaw and adjustable jaws and is then secured via the lever, 34, and, the jaws also rotate vertically 360 degrees via the knurled rotation grip, 22, and such rotation is secured via the micro-tension adjustment screw, 35. The double notches placed at the top of the jaw allow for maximum clamping on larger hooks. The offset between the top of the jaw and the hinge point provides most of the clamping force on the bend of the hook, which, in turn, leaves the shank of the hook free for tying. Jaws may be easily removed and disassembled for cleaning purposes.

For complete, simple left-hand/right-hand conversion, the clamping mechanism, 17, must be loosened via the lever, 18. Then, the horizontal post, 19, is rotated 180 degrees, vertically spinning the cam/jaw assembly 180 degrees, and then, the cam/jaw assembly must be rotated around the vertical post, 8, so that the jaws point back toward the front end of the pedestal, 1, and then, the lever, 18, is tightened to secure the cam/jaw assembly in place. Next the lever on the jaws, 34, must be removed from the fixed jaw, 31, and screwed back into the adjustable jaw, 33. Finally, the micro-tension adjustment screw, 35, in the bearing housing, 25, must be removed from the top of the bearing housing, 25, and screwed into the bottom of the bearing housing, 25.

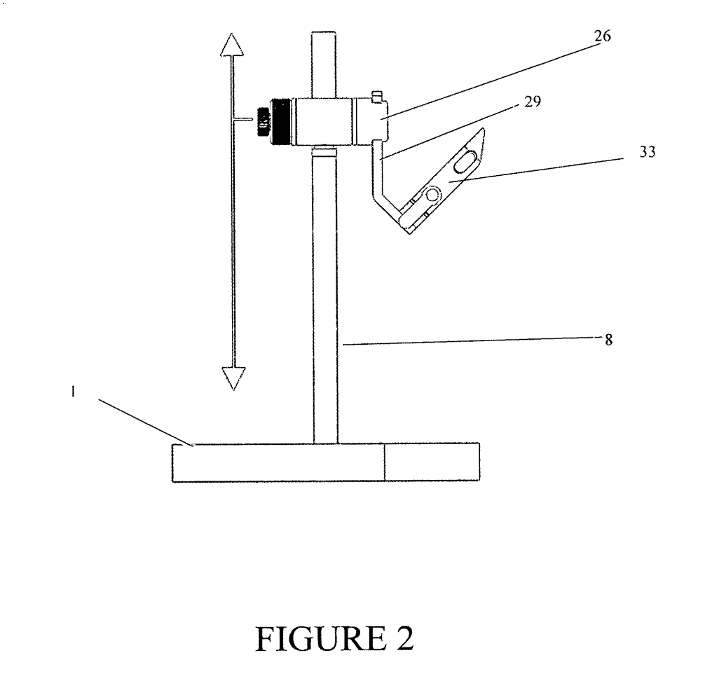

For purpose of FIGS. 2 through 11, if a part or feature was previously disclosed, the numbers of the parts/features in FIG. 1 correspond to the parts/features in FIGS. 2 through 11.

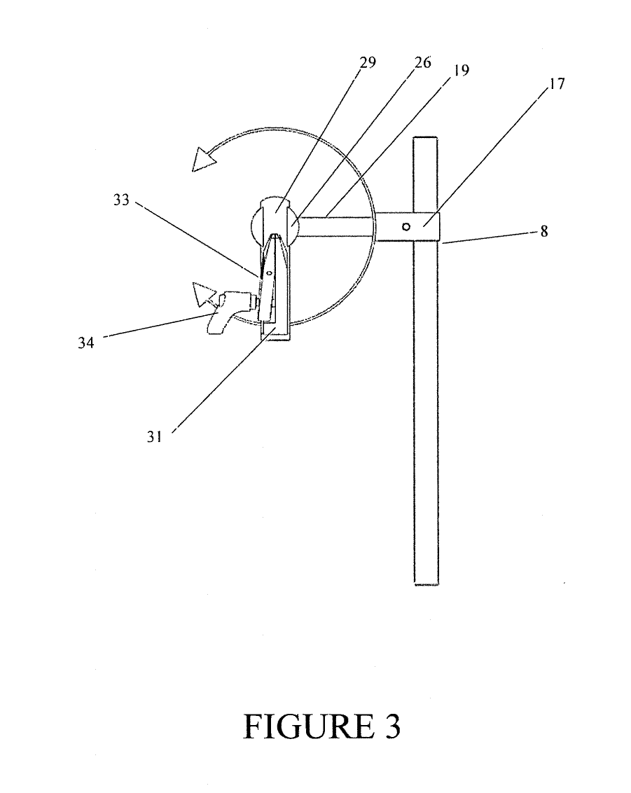

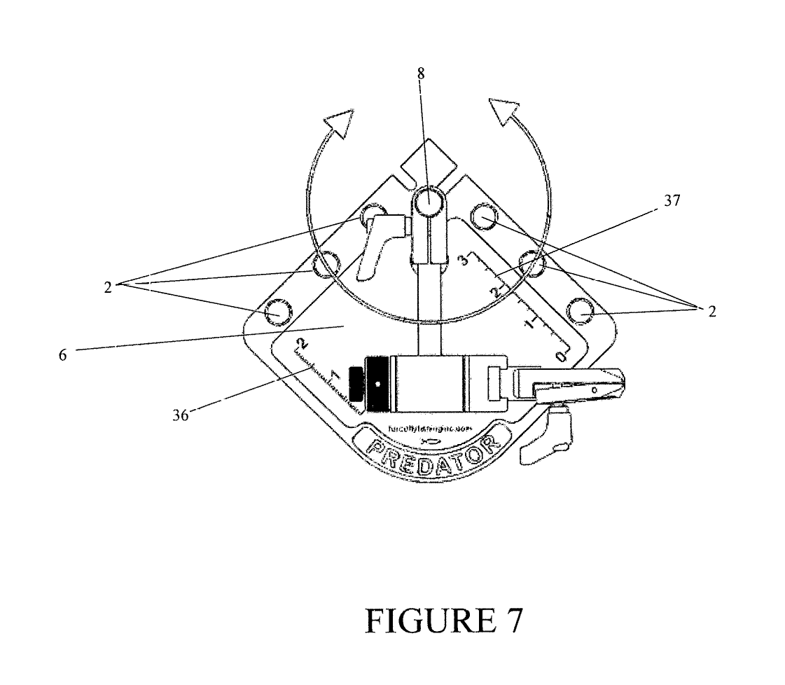

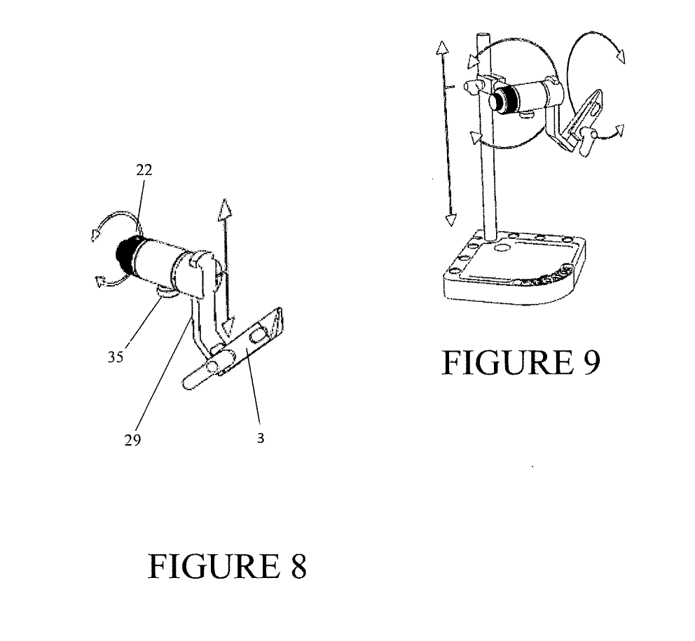

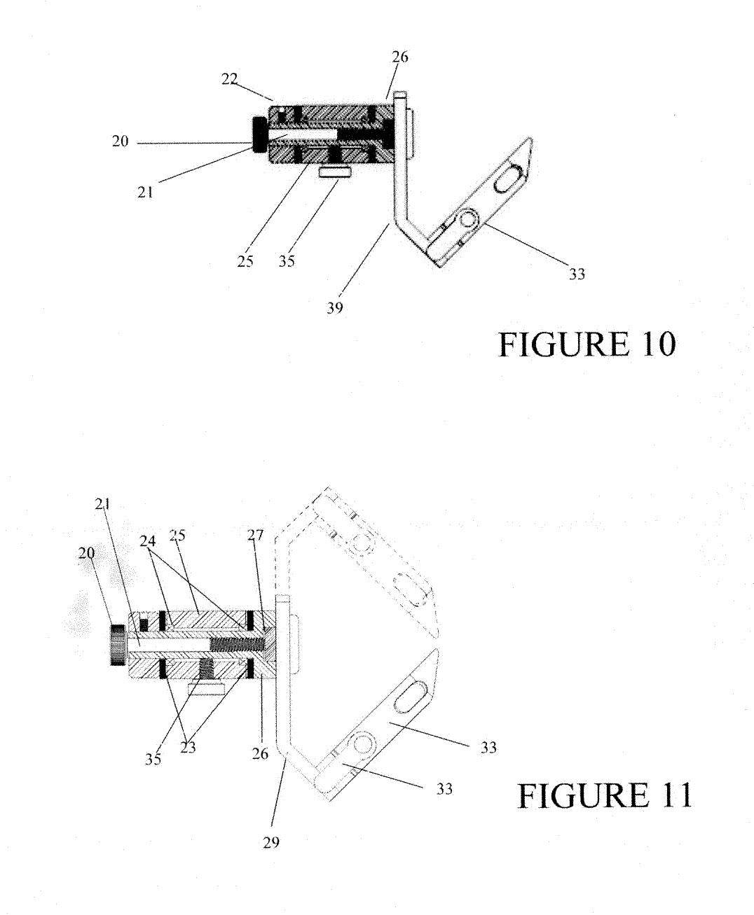

FIG. 2, demonstrates, via the arrow, the up and down movement of the cam/jaw assembly via the clamping mechanism. FIG. 3, demonstrates, via the arrow, the 360 degree vertical rotation of the jaws when the jaws are mounted to the angled jaw plate, and the attribute of having the vertical post at the back of the offset cam provides space around the vise without impeding hand movement. FIG. 4, which is a side, fragmentary view of the cam/jaw assembly, i.e. looking at the cam/jaw assembly straight-on from the perspective of the vertical post with the circle in the middle of the bearing housing, 25, being the location that the horizontal post is pressed into the bearing housing, demonstrates via the arrow, the 360 vertical rotation of the cam/jaw assembly via the horizontal post, 19. FIG. 5 is a perspective view of the vise, which shows the assembly of the straight jaw plate or the angled jaw plate in the jaw plate adjustment and the option between the two jaw plates and shows the contour of the jaws and the location between the hook and the hinge. This attribute will give the individual the ability to hold various hook sizes but also have the clamping force needed for tying larger and/or heavier flies. FIG. 6 (a top, elevational view of the vise), demonstrate the assembly of the straight jaw plate or the angled jaw plate in the jaw plate adjustment and the option between the two jaw plates. FIG. 7, demonstrates the horizontal, lateral 360 degree rotation of the cam/jaw assembly around the vertical post; the metric measurement system, 36, and the standard measurement system, 37, on the label, which is inserted into the milled-out, flat depression on the pedestal; and, the six tool-storage holes on the pedestal. FIG. 8, a perspective view of the cam/jaw assembly demonstrates the 360 degree vertical rotation of the jaws when cam/jaw assembly is, in the horizontal position (note: the jaws have rotate 360 degree horizontally when the cam/jaw assembly is in the vertical position) and the up and down, linear adjustability of the jaw plates in the jaw plate adjust. FIG. 9, a perspective view of the vise, demonstrates the 360 degree vertical rotation of the cam/jaw assembly; the 360 degree vertical rotation of the jaws when the cam/jaw assembly is in the horizontal position; and, the up and down, linear adjustability of the cam/jaw assembly via the clamping mechanism, 17. FIG. 10 and FIG. 11, both show external views of the jaws and cross-sectional views of the cam, and FIG. 11 demonstrates how the jaws can be rotated 180 degrees vertically.

Although the vise is stable with the cam/jaw assembly pointed anywhere within the four corners of the pedestal, the ideal placement of the main parts or features of the vise for balance and stability while tying with the cam/jaw assembly in the horizontal position, is with the back sides of the pedestal where the vertical post is mounted, placed farther away from the tier and the front sides of the pedestal placed closer to the tier, the tip of the jaws pointing toward the front end of the pedestal, with the horizontal post running approximately parallel to the back, right side of the pedestal (i.e. the side that makes up the right side of the back ninety degree corner of the pedestal), and the cam/jaw assembly running approximately parallel to the right front side of the pedestal. Similarly, the ideal placement of the main parts or features of the vise for balance and stability while tying with the cam/jaw assembly in the vertical position, is with the back sides of the pedestal where the vertical post is mounted, placed farther away from the tier and the front sides of the pedestal placed closer to the tier, with the tip of the jaws pointing upwards in line with the center of the front end of the pedestal, with the back end of the horizontal post pointing toward the back corner of the pedestal where the vertical post is mounted and the front end of the pedestal pointing toward the front end of the pedestal.

Another important aspect of the vise, is the ability to break it down for travel or for cleaning. The jaws, 31-34, are easily removed from the cam by releasing the jaw plate, 28 or 29, from the jaw plate adjust with the jaw plate release knob, 20. By removing the screw, 30, from the back of the jaw plate, 28 or 29, and the fixed jaw, 31, the jaws can be easily removed from the jaw plate, and then disassembled themselves by unscrewing lever, 34, and then pushing the hinge, 32, out. Next the cam, horizontal post, 19, and clamping mechanism, 17, can

In sum, the present invention claims 360 degree horizontal rotation of the vertical post, perpendicular to the stable pedestal, a horizontal plan. The cam, which houses the jaws, can be positioned in multiple ways at any given time: (i) it can be moved and secured at any position up and down the vertical post, parallel to the pedestal; (ii) it also claims 360 degree lateral rotation around the vertical post, parallel to the pedestal; (iii) then, the horizontal post connecting the cam to the vertical post provides a horizontal axis (running perpendicular to the vertical post and parallel to the pedestal) and can be rotated vertically 360 degrees on the horizontal axis, this being ideal for tying parachute patterns when the jaws are pointed upwards allowing the hook shank to be in a vertical position during horizontal rotation; (iv) finally, the cam itself has an internal horizontal axis (running perpendicular to the vertical post and horizontal post), which allows the tier to free spin the jaws or braked and secure the jaws in any desired position on a 360 degree horizontal, vertical, or any axis in between depending on the position of the cam itself as positioned in section (iii) of this paragraph. The jaws themselves, via the jaw plate that runs perpendicular to the jaws, can be positioned up and down along the jaw plate, allowing the tier to position the hook ideally to achieve perfectly balanced rotation regardless of hook size or position of the cam relative to the horizontal or vertical post. Meanwhile, the flexible back snatch can be positioned at almost any angle, allowing the tier to place the thread holder or material clip almost anywhere relative to the hook (within the 12″ reach of the flexible arm).

Any combination of the above-described simultaneous angular positioning options for the various parts of the AP Vise allow the tier to achieve an infinite number of unique positions that suit the tier's comfort and/or preference. While previous inventions have achieved one or maybe two of the above-described angular positions simultaneously, none have achieved the number of simultaneous angular positions claimed by the AP Vise. Furthermore, while few of the fly tying vises previously described have allowed conversion for both right and left handed tiers, no other vise has allowed the above-described positioning to be achieved conveniently by both right and left hand tiers by means of a simple conversion. The angular rotational markings on the cam, allow the tier to achieve substantially perfect alignment of the hook, to avoid tying tilted flies.

The up and down movement of the vise is also important for those that need to have the vise closer to their eyes for better viewing, comfort, or other relevant purposes. The implementation of the cam offset in relation to the jaws is an attribute of this invention. Keeping the hook on center is a key factor for tying ease and accuracy. With complete offset adjustment an individual can use various hook sizes without limitation.

While tying a fly, ideally the curve of the hook is placed in the jaws of the fly tying vise, which allows the shank to stand above and parallel to the jaws. This invention implements angular markings on the offset cam so that the proper angle can be achieved for a particular type of fly, allowing the fly tier a better chance to avoid tying tilted or askew flies. The friction adjustment is used to keep the jaws in place at a set angle for tying ease or can be disengaged to allow the jaws to free spin 360 degrees.

In sum, the AP Vise improves or solves the above-described issues with previous inventions as follows: The vise has a larger, more stable pedestal and when combined with the solid vertical post, which is taller than previous inventions, serve as a platform to hold the back snatch, cam, accessories, and accommodate heavier flies; Unlike previous inventions, the vise has a large, depressed flat area within the surface of the pedestal, that contains a rare earth magnet which attracts hooks and metal tools and serves to magnetized and re-magnetize the jaws and the pedestal has six large holes along the outside of the vise that hold tools; The offset cam does not restrict but allows 360 degree freedom of movement around the hook; The horizontal post allows for 360 degree rotation of the jaws, allowing the tier to turn the cam 90 degrees, changing the axis of tying rotation from horizontal or vertical, allowing the tier to tie parachute patterns; Vise easily adjusts to accommodate left-hand dominant and right-hand dominant fly tiers; The cam/jaw assembly is easily adjusted up and down the vertical post, allowing the tier to place the jaws closer or farther from their line of vision; (viii) Superior hook holding power due to improved tensioning system of the jaws; (ix) Angular indicators that align on the bearing housing and jaw plate adjust, help prevent the tier from tying tilted flies; (x) Swiveling, flexible back snatch that holds the bobbin thread holder and material pliers is also adjustable up and down, allowing the tier to move the back snatch almost anywhere the individual finds use for it; and, (xi) Includes both a straight jaw plate or angled jaw plate, to suit the preference of any tier.

### DETAILED DESCRIPTION OF THE PREFERRED EMBODIMENT

This invention, the vise, could be utilized in any field which requires close up, detailed work, on an item small and light enough to be secured by a stable structure that also allows for freedom of movement around the item and stable structure, i.e. this vise may be put to use by jewelers, medical practitioners, photographers, electronics, etc. In reality, the potential uses for this vise, are rather numerous within these limits. However, the preferred embodiment of this vise is for use in fly tying, where the fly tier uses the jaws to securely clamp the curve of the hook between the tip of the jaws, then adjusting the shank of the hook (depending on hook size) up and down within the jaw plate adjust until a perfect rotation is reached. Furthermore, the almost unlimited ability to adjust the location of the hook means that the tier can simply move the hook around in multiple directions to examine the fly.

It is considered within the scope of this invention that the vise (excluding the back snatch) may be constructed out of any type of strong, rigid material as long as the same balance, maneuverability, and stability is achieved. However, it is preferable for the jaws to be made of a magnetic strong metal material (as magnetization of the jaws with the rare earth magnet helps hold the hook in place while clamping the jaws around the hook), that is either hard enough to hold hooks or other items without spreading but soft enough so that it will not break due to brittleness, or a metal which can be hardened to achieve the same.

### Variations

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents, unless specifically stated otherwise. In other words, use of the articles allow for “at least one” of the subject item in the description above as well as the to be appended claims. It is further noted that the to be appended claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the to be appended claims shall allow for the inclusion of any additional element irrespective of whether a given number of elements are enumerated in the to be appended claim, or the addition of a feature could be regarded as transforming the nature of an element set forth in the to be appended claims. Except as specifically defined herein, all technical and scientific terms used herein are to be given as broad a commonly understood meaning as possible while maintaining to be appended claim validity.

The breadth of the present invention is not to be limited to the examples provided and/or the subject specification, but rather only by the scope of the to be appended claim language. Use of the term “invention” herein is not intended to limit the scope of the to be appended claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the to be appended claims. All references cited are incorporated by reference in their entirety. Although the foregoing invention has been described in detail for purposes of clarity of understanding, it is contemplated that certain modifications may be practiced within the scope of the to be appended claim.

What is claimed is:

1. A vise for holding objects (namely fly tying hooks) comprised of the following:
a larger-than-normal, essentially square pedestal with the back end that contains a mounting mechanism for a vertical post and the rounded-off front end; a vertical post that rotates horizontally 360 degrees in the pedestal; a back snatch, which is a highly flexible arm that holds a material clip or bobbin thread holder at the far end; a clamping mechanism that connects the horizontal post to the vertical post; and, a horizontal post that is connected to a cam that consists of multiple working parts, the end of said cam contains a slot wherein one of two jaw plates is inserted, with the jaw plate connecting to a set of jaws, with the combination of the cam and the jaws being referred to as the cam/jaw assembly.

2. The invention of claim 1, is further comprised of a heavy aluminum larger and taller-than-normal pedestal essentially in the shape of a square, with the back corner of said pedestal being where the sides meet at a ninety degree angle; the opposite ends of the two sides that make up the back corner are slightly rounded off; and, the front side (opposite the back) is rounded off to a smooth curve; and, the back corner of the pedestal which is comprised of a means for vertically, pivotally mounting a large, solid vertical post, which allows the vertical post to be rotated horizontally 360 degrees thereby also rotating the cam/jaw assembly; to be secured in place via the mounting bracket once the desired position is reached; and, to be completely removed for storage or travel, with such placement of said vertical post at the back corner of the pedestal being ideal for greater weight distribution when the cam/jaw assembly is placed at its recommended location toward the front corner of the pedestal, providing a good center of gravity stability during use.

3. The invention of claim 2, the pedestal, is further comprised of:
a total of 6 holes as each of the two sides that form the ninety degree back corner of the pedestal has three holes, drilled from the top of, down in to the pedestal along and near the edge, said holes being wide and deep enough wherein a wider range of fly tying tools may be inserted or stored without tipping over or falling out;
the top, center of the pedestal has a milled out flat area, with straight sides, deep enough (approximately ⅛″ deep) to help prevent tools, hooks, and other materials from sliding off of the pedestal, after a label (described hereafter) is inserted;
a hole drilled into the top of the pedestal toward the back corner in front of the vertical post, the hole being deep enough to place a strong rare earth magnet, over which the label is placed (described hereafter), which is inserted for purposes of attracting hooks and other metal tools and/or for magnetizing or recharging the magnetization of the jaws (claim 17); and,
a label that is sticky on the bottom side so that it attaches to and conforms to the shape of the milled-out, flat area, with the top side being used as a platform where tools, materials, and hooks can be stored; displaying metric measurement and standard measurement, for measuring flies and materials; and, displays a small circle which is placed over the top of said hole that contains the rare earth magnet to indicate where on the label the most magnetic pull is coming from for purposes of attracting metal hooks or placing the tip of the jaws for magnetizing or re-magnetizing.

4. The invention of claim 1, includes a wide, tall, solid vertical post made of steel that is positioned at the back corner of the pedestal allowing for a good center of gravity while tying a fly when the cam/jaw assembly is placed at its recommended location reaching toward the front corner of the vise and which is necessary to mount multiple portions of the vise including the back snatch, the offset cam/jaw assembly (which is connected to the vertical post by a clamping mechanism and a horizontal post), and other snap-on tools and future accessories designed for compatibility with the invention of claim 1.

5. The invention according to claim 1, is further comprised of a back snatch, which serves as a highly flexible, yet strong and stable arm that can be positioned by the tier to put the thread holder or material pliers near the hook or in any number of desired positions or removed entirely, and is attached to the vertical post via a mounting bracket, which allows the back snatch to move up and down and rotate horizontally 360 degrees around the vertical post and allows the back snatch to be removed entirely if desired; with said mounting bracket attached to a threaded connecter, which attaches to a highly flexible, yet stable, modular hose, that can be adjusted as desired by the tier; with the modular hose of the back snatch being screwed into a nozzle that attaches to a tip, which contains a slot where the rod of a material clip or bobbin thread holder, may be inserted, and then secured by a screw.

6. The invention according to claim 1, is further comprised of a clamping mechanism, which connects the horizontal post to the vertical post, the clamping mechanism being comprised of two separate pieces that when placed properly together are essentially mirror images of each other (except for minor differences in the holes that are drilled into them for the lever), and when placed together form a hole through the center that encases the vertical post which is inserted through the bottom of the clamping mechanism; said two pieces on the back side, behind the vertical post, coming together to form a smooth curve and enclose the vertical post and the other side being held together by a lever that is inserted through the holes drilled on either side of each separate piece of the clamping mechanism with said lever holding the vertical post in place; with the front end of said two pieces forming another hole at the front wherein the horizontal post is inserted; and, said clamping mechanism, when loosened by said lever, allows the cam/jaw assembly to move both vertically up and down the vertical post; to rotate horizontally 360 degrees around the vertical post (which is also crucial for left-hand/right-hand conversion); and, to rotate vertically 360 degrees via the horizontal post.

7. The invention according to claim 1, is further comprised of a horizontal post, which is a solid, horizontal cylinder that connects to the vertical post on the back end via the clamping mechanism and, on the other end, is pressed into the bearing housing of the cam, with said horizontal post, when rotated, allows the cam/jaw assembly to rotate vertically 360 degrees and, specifically,
allowing the cam to be turned 90 degrees with the straight jaw (described below), allowing the tier to turn the jaws and change the axis of tying rotation from horizontal to vertical, i.e. allowing an individual to tie parachute patterns; or,
allowing the cam to be turned 180 degrees, which is crucial for left-hand/right-hand conversion.

8. The invention according to claim 1, is further comprised of a cam/jaw assembly, which is set approximately a hand's width away from and offset from the vertical post, allowing the freedom of hand movement around the entire cam/jaw assembly in turn giving complete accessibility to the fly while tying; and said cam/jaw assembly includes the jaw plate release (at the back end), the knurled rotation grip, the bearing housing (which said horizontal post is pressed into), the jaw plate adjust; the jaw plate (either a straight jaw plate or angled jaw plate), and a set of jaws.

9. The invention according to claim 8, the first part of which is comprised of a three-part piece, called the jaw plate release, which starts at the back end of the cam with a black knob that is attached to a long screw, which is inserted at the back end of the cam, runs through the entire cam (including the shaft of the jaw plate adjust, described in claim 13), and puts pressure on the third part of the jaw plate release, which is a small disk, that sits inside the vertical notch of the jaw plate adjust (claim 13), and when said jaw plate release knob, is turned clockwise, said long screw, puts pressure on said small disk inside the jaw plate adjust, thereby securing the jaw plate (claim 14), and, conversely, when said jaw plate release knob, is turned counter-clockwise, said small disk goes back into its place in the jaw plate adjust (claim 13) taking pressure off of the jaw plate (claim 14), thereby releasing the jaw plate allowing the tier to release and jaw exchange jaw plates easily.

10. The invention according to claim 8, the second part of which is comprised of a hollow cylinder, knurled on the outside for grip, and being called the knurled rotation grip, is placed directly in front of the jaw plate release and inserted around the long screw (described above in claim 9) and the shaft of the jaw plate adjust (claim 13), and directly in front of the black knob of the jaw plate release, with said knurled rotation grip rotating in unison with the jaw plate adjust (claim 13), jaw plate (claim 14), and jaws (claim 17), allowing the tier to turn said knurled rotation grip, thereby rotating said jaw plate and jaws vertically 360 degrees when the cam is in the horizontal position or rotate said jaw plate and jaws horizontally 360 degrees when the cam is in the vertical position.

11. The invention according to claim 8, the third part of which is called the bearing housing, is comprised of a hollow cylinder into the side of which the horizontal post (claim 7) is pressed, which is placed in front of the knurled rotation grip (claim 10), around the long screw of the jaw plate release (claim 9), and shaft of the jaw plate adjust (claim 13), after one of two large nylon washers is inserted, with the back end (closest to the knurled rotation grip and the first washer) and the front end (closest to the second washer and jaw plate adjust) of the bearing housing have identical sealed ball-bearings, pressed into them, which, unlike the knurled rotation grip (claim 10) and the jaw plate adjust (claim 13) the bearing housing, remains stationary when the knurled rotation grip is turned, but when the horizontal post is turned, the bearing housing, turns in unison with it, thereby turning the entire cam/jaw assembly.

12. The invention according to claim 11, is further comprised of
another hole that is drilled through the top and bottom of said bearing housing, wherein a screw is inserted that serves as a micro-tension adjustment screw, that when tightened, places pressure on the tubular-shaft portion of the jaw plate adjust (claim 13), thereby stopping the free-spin rotation of the jaws (claim 17) securing the jaws in the desired position, with said hole drilled through the top and bottom of the bearing housing, also serving to allow easy left-hand/right-hand conversion by screwing the micro-tension adjustment screw into the other side of the bearing housing, once the cam via the horizontal post is rotated 180 degrees (as described in claim 7), and
angular indicator markings on the front end, every ninety degrees and every fifteen degrees between the ninety degree marks, which align with the angular markings on the back end of the jaw plate adjust (claim 13), for indicating trueness of plane while tying.

13. The invention according to claim 8, the fourth part of which is called the jaw plate adjust, is comprised of a cylinder with a internally male-threaded hollow shaft at its back end which points toward the back of the cam through which the long screw of the jaw plate release (claim 9) is screwed into; said jaw plate adjust is placed in front of the bearing housing, after the second of two large, nylon washers is inserted; the front end of the jaw plate adjust, has a vertical notch cut into it with a countersunk hole in the center, inside which the small disk, i.e. the third part of the jaw plate release (claim 9), is inserted, with the vertical notch being designed where one of either jaw plates, i.e. the straight jaw plate (claim 15) or the angled jaw plate (16), is inserted, adjusted, and secured in order to mount the jaws (claim 17); and, the back end of the jaw plate adjust has angular indicator markings that correspond to the angular indicator markings on the bearing housing, which, by lining up the angular indicator markings on the bearing housing (claim 12) and the jaw plate adjust, the tier can avoid tying tilted flies, offering a more precision in tying than ever before.

14. The invention according to claim 1, is comprised of metal plates, called jaw plates, that are inserted into the jaw plate adjust described in claim 13 and secured or released by the jaw plate release described in claim 9; unlike any previous fly tying vise, give the fly tier a choice between tying with straight-neck jaws (“straight jaws”) or angled-neck jaws (“angled jaws”); and, unlike any previous fly tying vise, each jaw plate allows the tier to adjust the jaws up and down within the notch of the jaw plate adjust (claim 13), letting the tier adjust the position of any size hook to allow the shank of the hook to rotate on a perfect center axis, as opposed to prior art, which only allowed the jaws to rotate on a perfect center axis

15. The invention according to claim 14, includes a straight jaw plate, is comprised of a rectangular metal piece which is approximately 1¼ inches long and straight on the bottom end and rounded on the top end; with the thickness and width designed to fit into the notch of the jaw plate adjust (claim 13); with a chamfered hole that has an inside diameter of approximately ¼ inch wide drilled through the middle close to the bottom end of said straight jaw plate wherein a screw is inserted and used to mount the jaws (claim 17) perpendicular to said straight jaw plate; and, which drops straight down from, is parallel to, and which is inserted into the notch of the jaw plate adjust (claim 13).

16. The invention according to claim 14, includes an angled jaw plate, is comprised of a rectangular metal piece which is approximately 4 inches long, straight on the bottom end and rounded on the top end, and bent at a 135 degree angle approximately 1¼ inches from the straight end; with the thickness and width designed to fit into the notch of the jaw plate adjust (claim 13); with a chamfered hole that has an inside diameter of approximately ¼ inch wide drilled through the middle close to the bottom end of said angled jaw plate wherein a screw is inserted and used to mount the jaws (claim 17); and, which drops straight down from the jaw plate adjust (claim 13) and then bends up and away from the jaw plate adjust at a 135 degree angle.

17. The vise, according to claim 1, is comprised of a set of jaws that hold the hook or other object in place, the jaws being comprised of an adjustable jaw, a fixed jaw, a hinge pin, and a lever; with the fixed jaw having an oval post and the adjustable jaw having a corresponding oval hole wherein the oval post of the fixed jaw is inserted; with said oval post of the fixed jaw having a small hole drilled into it that lines up with a small hole drilled into the adjustable jaw, so that when the fixed jaw and the adjustable jaw are placed property together, a small hinge pin may be inserted, thereby connecting the fixed and adjustable jaws; with the adjustable jaw and fixed jaw having tap-threaded female holes drilled through the sides of each jaw toward the back end, into which a lever is screwed (either into the fixed jaw for left-hand tiers or into the adjustable jaw for right-hand tiers); with the lever providing pressure against the opposite jaw toward the back, pushing it open at the back, which, in turn, applies pressure to the tip of the jaws, where the hook is placed; with the jaws being angled down and back from the tip, to allow for greater access to the hook so that the tier does not have to reach over any obstructions; with the jaws being attached perpendicular to the jaw plate, either the straight jaw plate (claim 15) or the angled jaw plate (claim 16), by a small screw, which is inserted through the angled or the straight jaw plate into the back of the fixed jaw; which function by a hook being inserted into the tip of the jaws between the fixed jaw and adjustable jaws which and is then secured via said lever; being able to rotate vertically 360 degrees via the knurled rotation grip (claim 10), with such rotation being stopped and secured via the micro-tension adjustment screw (claim 12), allowing the jaws to rotate 360 degrees vertically when the cam/jaw assembly (claim 8) is placed in a horizontal position via the horizontal post (claim 7) and clamping mechanism (claim 6), or allowing the jaws to rotate 360 degrees horizontally when the cam/jaw assembly (claim 8) is placed in a vertical position via the horizontal post (claim 7) and clamping mechanism (claim 6); with the double notches placed at the top of the jaw that allow for maximum clamping on larger hooks; with the offset between the top of the jaw and the hinge point provides most of the clamping force on the bend of the hook, which, in turn, leaves the shank of the hook free for tying; with the lever on the jaws, which may be removed from the fixed jaw, and screwed back into the adjustable jaw, for left-hand/right-hand conversion; and, being easily removed and disassembled for cleaning purposes.
